(19) United States
(12) Patent Application Publication
(10) Pub. No.: US 2019/0349813 A1
(43) Pub. Date: Nov. 14, 2019

(54) METHOD FOR CONTROLLING FLOW AND APPARATUS FOR SUPPORTING SAME

(71) Applicant: LG Electronics Inc., Seoul (KR)

(72) Inventors: Seokjung Kim, Seoul (KR); Jian Xu, Seoul (KR); Deaewook Byun, Seoul (KR)

(21) Appl. No.: 16/474,619

(22) PCT Filed: Dec. 26, 2017
(86) PCT No.: PCT/KR2017/015474

§ 371 Date: Jun. 28, 2019

Related U.S. Application Data
(60) Provisional application No. 62/440,386, filed on Dec. 29, 2016.

(51) Int. Cl. H04W 28/12; H04W 76/27

(52) U.S. Cl. CPC H04W 28/12; H04W 88/08; H04W 76/27

(57) ABSTRACT

Disclosed is a method for controlling, by a base station, a flow in a wireless communication system. The method comprises the steps of: transmitting, to a terminal, an indicator indicating that the terminal is to enter an RRC inactive state; requesting a core network to interrupt at least a portion of the flow as the terminal enters the RRC inactive state; receiving uplink data from the terminal in the RRC inactive state; determining, on the basis of the uplink data, whether the terminal should enter an RRC connection state; and transmitting the uplink data to the core network according to the determination result.

### CROSS-REFERENCE TO RELATED APPLICATIONS

This application is the National Stage filing under 35 U.S.C. 371 of International Application No. PCT/KR2017/015474, filed on Dec. 26, 2017, which claims the benefit of U.S. Provisional Application No. 62/440,386 filed on Dec. 29, 2016, the contents of which are all hereby incorporated by reference herein in their entirety.

### BACKGROUND OF THE INVENTION

### Field of the invention

The present invention relates to a method for controlling a flow between a base station and a core network when a UE is in an RRC_INACTIVE state.

### Related Art

In order to meet the demand for wireless data traffic since the 4th generation (4G) communication system came to the market, there are ongoing efforts to develop enhanced 5th generation (5G) communication systems or pre-5G communication systems. For the reasons, the 5G communication system or pre-5G communication system is called the beyond 4G network communication system or post long-term evolution (LTE) system.

Meanwhile, in order to uniformly manage an operation state of a UE, an upper layer standard defines a protocol state and presents detailed functions and procedures of the UE. In discussion of NR standardization, an RRC state is defined as an RRC_CONNECTED state and an RRC_IDLE state, and introduction of an RRC_INACTIVE state is further considered.

The RRC_INACTIVE state may be a concept similar to a lightly connected node that is being discussed in LTE. The RRC_INACTIVE state has been introduced to efficiently manage a specific UE (e.g., an mMTC terminal). A UE in the RRC_INACTIVE state performs a wireless control procedure in a similar way as does a UE in the RRC_IDLE state. However, In order to minimize a control procedure necessary to transition to the RRC_CONNECTED state, a connection state between the UE and a network is maintained in a similar way as in the RRC_CONNECTED state. In the RRC_INACTIVE state, a wireless access resources is released but wired connection may be maintained.

### SUMMARY OF THE INVENTION

In an RRC_INACTIVE state newly defined in NR, wired connection between a base station and a core network (corresponding to both a control plane and a user plane). Even in this case, however, it is not necessary to maintain all flows between the base station and the core network. Thus, a new method for controlling a flow between the base station and the core network in the RRC_INACTIVE state is required.

According to an embodiment of the present invention, there is provides a method for controlling a flow by a base station in a wireless communication system, the method including: transmitting, to a UE, an indicator indicating that the UE is to enter an RRC_INACTIVE state; requesting a core network to suspend at least a portion of the flow as the UE enters the RRC_INACTIVE state; receiving uplink data from the UE in the RRC_INACTIVE state; determining whether the UE needs to enter an RRC_CONNECTED state based on the uplink data; and transmitting the uplink data to the core network based on a result of the determination.

The flow may be an element of a session established between the base station and the core network.

The determining of whether the UE needs to enter the RRC_CONNECTED state may include, when a size of the uplink data is smaller than a preset value and there is no downlink data to be transmitted to the UE, determining that the UE does not need to enter the RRC_CONNECTED state.

When the result of the determination indicates that the UE does not need to enter the RRC_CONNECTED state, the transmitting of the uplink data may include transmitting the uplink data using an operating flow, except an suspended flow.

When the result of the determination indicates that the UE needs to enter the RRC_CONNECTED state, the transmitting of the uplink data may include: requesting the core network to resume a suspended flow; and receiving, from the core network, a notification indicating that the suspended flow is resumed.

The requesting of the core network to resume the suspended flow may include transmitting ID of an NG application protocol between the base station and the UE (gNB UE NGAP ID) and ID of an NG application protocol (NGC UE NGAP ID) between the core network and the UE to the core network.

The receiving of the uplink data from the UE may include receiving UE identity (ID) and a short message authentication code for integrity (short MAC-I) from the UE.

The method may further include, after the determining of whether the UE needs to enter the RRC_CONNECTED state, transmitting, to the UE, an RRC state indicator indicating that whether to enter the RRC_CONNECTED state or maintain an RCC_INACTIVE state.

The transmitting of the RRC state indicator may include transmitting Cell-Radio Network Temporary Identifier (C-RNTI) and tracking area identity (TAI( ) to the UE.

According to another embodiment of the present invention, there is provided a method for controlling a flow by a core network in a wireless communication system, the method including: receiving a request, from a base station, to suspend at least a portion of the flow as a UE enters an RRC_INACTIVE state; suspending the at least the portion of the flow requested to suspend; when downlink data to be transmitted to the UE is generated, determining whether the UE needs to enter the RRC_CONNECTED state based on the downlink data; and transmitting the downlink data to the base station based on a result of the determination.

The flow may be an element of a session established between the base station and the core network.

The determining of whether the UE needs to enter the RRC_CONNECTED state may include, when a size of the downlink data is smaller than a preset value, determining that the UE does not need to enter the RRC_CONNECTED state.

When the determination result indicates that the UE does not need to enter the RRC_CONNECTED state, the transmitting of the downlink data may include transmitting the downlink data using an ongoing flow, except a suspended flow.

When the result of the determination indicates that the UE needs to enter the RRC_CONNECTED state, the transmitting of the uplink data may include resuming the suspended flow; and transmitting, to the base station, a notification indicating that the suspended flow is resumed.

According to yet another embodiment of the present invention, there is provided a base station for controlling a flow in a wireless communication system, the base station comprises a memory, a transceiver, and a processor configured to connect the memory and the transceiver, wherein the processor is further configured: transmit, to a UE, an indicator indicating that the UE is to enter an RRC_INACTIVE state; request a core network to suspend at least a portion of the flow as the UE enters the RCC_INACTIVE state; receive uplink data from the UE in the RCC_INACTIVE state; determine, on the basis of the uplink data, whether the UE needs to enter an RRC_CONNECTED state; and transmit the uplink data to the core network based on a result of the determination.

According to embodiments of the present invention, the base station is capable of controlling a flow according to an RRC state of the UE and efficiently managing a resource for the UE. In addition, the core network in NR is capable of being aware of an actual RRC state of the UE based on signaling between the base station and the core network and providing a specific process for the UE even in

### BRIEF DESCRIPTION OF THE DRAWINGS

FIG. 1 illustrates a structure of an Long Term Evolution (LTE) system.

FIG. 2 illustrates a wireless interface protocol of an LTE system for a control plane.

FIG. 3 illustrates a wireless interface protocol of an LTE system for a user plane.

FIG. 4 illustrates a 5G network structure.

FIG. 5 is a flowchart illustrating a method for controlling a flow according to an embodiment of the present invention.

FIG. 6 is a flowchart illustrating a method for controlling a flow according to another embodiment of the present invention.

FIG. 7 is a flowchart illustrating a method for controlling a flow according to an embodiment of the present invention.

FIG. 8 is a flowchart illustrating a method for controlling a flow according to another embodiment of the present invention.

FIG. 9 is a block diagram of a communication system in which an embodiment of the present invention is implemented.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with a system based on the IEEE 802.16e. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE. 5G is an evolution of the LTE-A.

For clarity, the following description will focus on LTE-A. However, technical features of the present invention are not limited thereto.

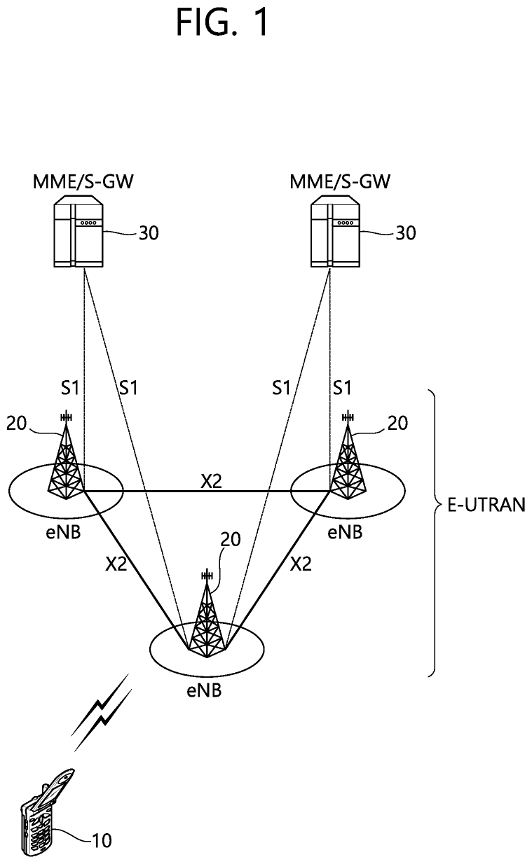

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

The eNB 20 provides an end point of a control plane and a user plane to the UE. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a serving gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

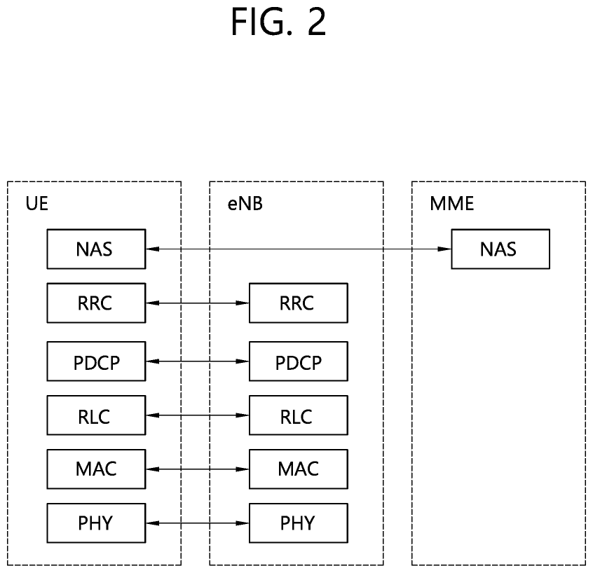

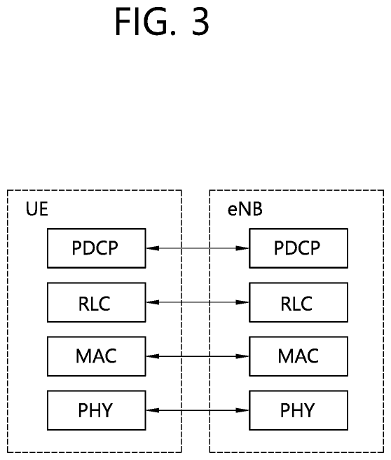

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel The MAC layer provides a function of mapping multiple logical channels to multiple transport channels. The MAC layer also provides a function of logical channel multiplexing by mapping multiple logical channels to a single transport channel A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

A non-access stratum (NAS) layer belongs to an upper layer of the RRC layer and serves to perform session management, mobility management, or the like.

Hereinafter, a 5G Network Structure is Described.

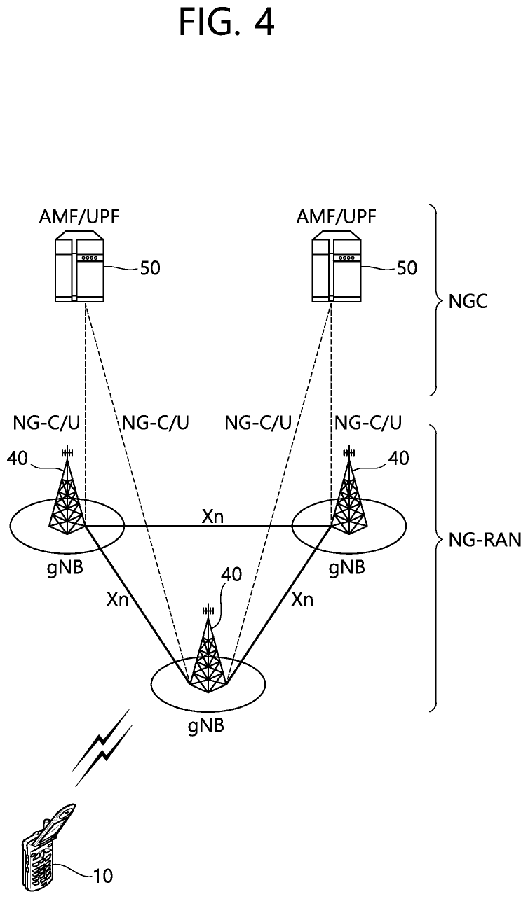

FIG. 4 shows a structure of a 5G system.

In case of an evolved packet core (EPC) having a core network structure of the existing evolved packet system (EPS), a function, a reference point, a protocol, or the like is defined for each entity such as a mobility management entity (MME), a serving gateway (S-GW), a packet data network gateway (P-GW), or the like.

On the other hand, in case of a 5G core network (or a NextGen core network), a function, a reference point, a protocol, or the like is defined for each network function (NF). That is, in the 5G core network, the function, the reference point, the protocol, or the like is not defined for each entity.

Referring to FIG. 4, the 5G system structure includes at least one UE 10, a next generation-radio access network (NG-RAN), and a next generation core (NGC).

The NG-RAN may include at least one gNB 40, and a plurality of UEs may be present in one cell. The gNB 40 provides the UE with end points of the control plane and the user plane. The gNB 40 is generally a fixed station that communicates with the UE 10 and may be referred to as another terminology, such as a base station (BS), a base transceiver system (BTS), an access point, or the like. One gNB 40 may be arranged in every cell. At least one cell may be present in a coverage of the gNB 40.

The NGC may include an access and mobility function (AMF) and a session management function (SMF) which are responsible for a function of a control plane. The AMF may be responsible for a mobility management function, and the SMF may be responsible for a session management function. The NGC may include a user plane function (UPF) which is responsible for a function of a user plane.

Interfaces for transmitting user traffic or control traffic may be used. The UE 10 and the gNB 40 may be connected by means of a Uu interface. The gNBs 40 may be interconnected by means of an X2 interface. Neighboring gNBs 40 may have a meshed network structure based on an Xn interface. The gNBs 40 may be connected to an NGC by means of an NG interface. The gNBs 40 may be connected to an AMF by means of an NG-C interface, and may be connected to a UPF by means of an NG-U interface. The NG interface supports a many-to-many-relation between the gNB 40 and the AMF/UPF 50.

A gNB host may perform functions such as functions for radio resource management, IP header compression and encryption of user data stream, selection of an AMF at UE attachment when no routing to an AMF can be determined from the information provided by the UE, routing of user plane data towards UPF(s), scheduling and transmission of paging messages (originated from the AMF), scheduling and transmission of system broadcast information (originated from the AMF or O&M), or measurement and measurement reporting configuration for mobility and scheduling.

An access and mobility function (AMF) host may perform primary functions such as NAS signaling termination, NAS signaling security, AS security control, inter CN node signaling for mobility between 3GPP access networks, idle mode UE reachability (including control and execution of paging retransmission), tracking area list management (for UE in idle and active mode), AMF selection for handovers with AMF change, access authentication, or access authorization including check of roaming rights.

A user plane function (UPF) host may perform primary functions such as anchor point for Intra-/inter-RAT mobility (when applicable), external PDU session point of interconnect to data network, packet routing & forwarding, packet inspection and user plane part of policy rule enforcement, traffic usage reporting, uplink classifier to support routing traffic flows to a data network, branching point to support multi-homed PDU session, QoS handling for user plane, e.g. packet filtering, gating, UL/DL rate enforcement, uplink traffic verification (SDF to QoS flow mapping), transport level packet marking in the uplink and downlink, or downlink packet buffering and downlink data notification triggering.

A session management function (SMF) host may perform primary functions such as session management, UE IP address allocation and management, selection and control of UP function, configuring traffic steering at UPF to route traffic to proper destination, controlling part of policy enforcement and QoS, or downlink data notification.

Hereinafter, an RCC_INACTIVE State of a UE is Described.

In the discussion on the NR standardization, an RRC_INACTIVE state (RRC inactive state) has been newly introduced in addition to the existing RRC_CONNECTED state and RRC_IDLE state. The RRC_INACTIVE state may be a concept similar to a lightly connected mode which is under discussion in LTE. The RRC_INACTIVE state is a state introduced to efficiently manage a specific UE (for example, mMTC UE). A UE in the RRC_INACTIVE state performs a radio control procedure similarly to a UE in the RRC_IDLE state in order to reduce power consumption. However, the UE in the RRC_INACTIVE state maintains a connection state between the UE and a network similarly to the RRC_CONNECTED state in order to minimize a control procedure required when transitioning to the RRC_CONNECTED state. In the RRC_INACTIVE state, a radio access resource is released, but wired access may be maintained. For example, in the RRC_INACTIVE state, the radio access resource is released, but an NG2 interface between a gNB and am NGC or an S1 interface between an eNB and an EPC may be maintained. In the RRC_INACTIVE state, a core network recognizes that the UE is normally connected to a BS.

Meanwhile, in an RRC_INACTIVE state newly defined in NR, a wired connection between a base station and a core network (corresponding to both a control plane and a user plane) may be maintained. However, even in this case, every flow between the base station and the core network cannot be maintained. Therefore, a new method for controlling a flow between the base station and the core network in an RRC_INACTIVE state is required.

In the present disclosure, a flow is the minimum unit of a session and refers to a user traffic. The flow may be established between a UE and a core network (e.g., P-GW). In addition, flows may be grouped into a session by QoS, and a group session may be mapped with a bearer.

In addition, in the present disclosure, a base station may refer to a gNB in the NR, and a core network may refer to a Nest Generation Core (NGC). In addition, connection between the base station and the core network may be NG connection. However, these terms are distinguished based on the above-described operations and functions and may be changed depending on a case.

If a UE enters an RRC_INACTIVE state, connection between a base station connected to the UE and a core network may be maintained. If uplink data to be transmitted to the base station is generated in the RRC_INACTIVE state, the UE may transmit the uplink data by transitioning to the RRC connected state. However, a method for transmitting, by a UE in the RRC_INACTIVE state, uplink data to a base station without transitioning to the RRC connected state have been being discussed.

According to the present embodiment, a method for suspending, by a UE in an RRC_INACTIVE state, an unnecessary flow between a base station and a core network as well as transmitting data is proposed. Specifically, even in the case where the UE in the RRC_INACTIVE state transmits data to a core network, if a size of uplink data is sufficiently small, it is not necessary to maintain every flow between the base station and the core network. In other words, in the case where the UE in the RRC_INACTIVE state transmits uplink data to the core network, not all flows between the base station and the core network may operate. Thus, if the UE is in the RRC_INACTIVE state, uplink data of a small size may be transmitted to the core network without maintaining all flows between the base station and the core network. In the case where the UE is in the RRC_INACTIVE state, it is possible to reduce resource costs on the side of the base station and the core network by suspending all other flows, except for some flows between the base station and the core network. On the contrary, if the uplink data has a big size, the UE may transition to the RRC connected state, and, in this case, the suspended flows may be resumed.

Hereinafter, a method for controlling a flow between a base station and a core network according to an RRC state of a UE will be described. According to an embodiment of the present invention, if the UE is in the RRC_INACTIVE state, the base station may notify the core network of a flow necessary to suspend.

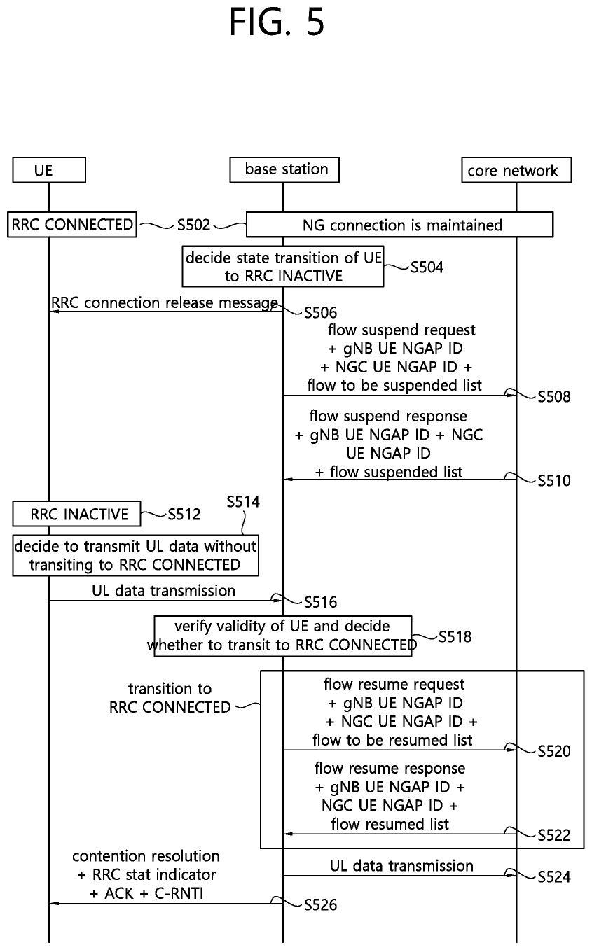

FIG. 5 is a flowchart illustrating a method for controlling a flow according to an embodiment of the present invention.

In step S502, a UE may be in an RRC connected state.

In step S504, if data is not transmitted in a preset period of time, the UE in the RRC connected state may determine to transition to an RRC_INACTIVE state.

In step S506, a base station may transmit an RRC connection release message. The RRC connection release message may include an indicator indicating that the UE is to enter the RRC_INACTIVE state. The RRC connection release message may include UE ID allocated by a previous serving base station, and, if the corresponding UE wishes to communicate with the base station, the base station may identify UE context using the UE ID. However, the indicator indicating the RRC_INACTIVE state and/or the UE ID is not necessarily transmitted through the RRC connection release message and instead may be transmitted through a new message in a different format.

In step S508, the base station may transmit a flow suspend request message including a list of flows necessary to be suspended as the UE transitions to the RRC_INACTIVE state. Here, the flows necessary to be suspended may indicate flows that is not operable without the UE's entering the RRC_CONNECTED state. That is, the base station may request to suspend all other flows, except for the minimum flows that are operable even though the UE is in the RRC_INACTIVE state. For example, whether it is necessary to be suspended may be preset for each flow depending on whether a corresponding flow is operable even in the RRC_INACTIVE state, whether the corresponding flow is frequently requested or highly referred by a user, or the like. In addition, a flow necessary to be suspend may be set by a user or a network. The flow suspend request message may include ID of an NG application protocol between the base station and the UE (gNB UE NGAP ID) and ID of an NG application protocol (NGC UE NGAP ID). The gNB UE NGAP ID and the NGC UE NGAP I may be allocated to the UE by the base station and the core network, respectively. However, this information is not necessary transmitted through the flow suspend request message and instead may be transmitted through a new message in a different format.

In step S510, the core network may transmit a flow suspend response message to the base station in response to the flow suspend request message. The flow suspend response message may include a list of flows suspended by the core network. In response to receiving the flow suspend request message from the base station, the core network may recognize that the UE is in the RRC_INACTIVE state. In other words, the core network may recognize the flow suspend request message as an indicator indicating the RRC state (RRC_INACTIVE state) of the UE. However, this information is not necessary transmitted through the flow suspend request message and instead may be transmitted through a new message in a different format.

In step S512, the UE may enter the RRC_INACTIVE state in response to receiving the RRC connection release message from the base station (see the step S506).

In step S514, if uplink data is generated, the UE may determine to transmit the uplink data, without transitioning to the RRC_CONNECTED state.

In step S516, the UE may transmit the uplink data to the base station. In this case, the UE may transmit UE ID and a short message authentication code for integrity (short MAC-I) to the base station. The UE ID is UE ID for the UE in the RRC_INACTIVE state and may be used to identify UE context in a previous serving cell. In addition, the short MAC-I is identification information having a small size and may be used to confirm effectiveness of the UE. At this step, the UE may transmit the uplink data in spite of the RRC_INACTIVE state. For example, the UE may transmit the uplink data through a simple RACH procedure that is composed of two or four main steps. However, the procedure of transmitting uplink data by a UE is not limited to the above-described procedure.

In step S518, the base station may confirm the effectiveness of the UE based on the UE ID and the short MAC-I received from the UE. If the effectiveness of the UE is confirmed, the base station may determine whether the UE needs to enter the RRC_CONNECTED state. Specifically, if the uplink data transmitted from the UE has a big size or there is downlink data to be transmitted to the UE, the base station may determine that the UE needs to enter the RRC_CONNECTED state. That is, the fact that the UE needs to enter the RRC_CONNECTED state may mean that it is difficult to perform a series of operations including transmitting of uplink data, simply by a flow maintained between the base station and the core network. If the uplink data transmitted from the UE has a small size and there is no downlink data, the base station may determine that the UE is capable of maintaining the RRC_INACTIVE state. That is, in the case where it is possible to transmit uplink data when some flows are currently suspended, the base station may determine that the UE is capable of maintaining the RRC_INACTIVE state. However, the downlink data is an ACK message for the uplink data, the downlink data has a size small enough, and thus, the downlink data may be transmitted to the UE without the UE's entering the RRC state. Therefore, according to an embodiment of the present invention, if there is downlink having a size equal to or greater than a preset value, the base station may determine that the UE needs to enter the RRC state.

In step S520, if it is determine that the UE needs to enter the RRC_CONNECTED state, the base station may transmit a flow resume request message to the core network. The flow resume request message may include a list of flows necessary to be resumed as the UE enters the RRC_CONNECTED state. In addition, the flow resume request message may include ID of an NG application protocol between the base station and the UE (gNB UE NGAP ID) and ID of an NG application protocol (NGC UE NGAP ID). However, this information is not necessary transmitted through the flow suspend request message and instead may be transmitted through a new message in a different format.

At step S522, in response to the flow resume request message, the core network may transmit a flow resume response message to the base station. The flow resume response message may include a list of flows resumed by the core network. In addition, in response to receiving the flow resume request message from the base station, the core network may recognize that the UE is in the RRC_CONNECTED state. In other words, the core network may recognize the flow resume request message as an indicator indicating the RRC state of the UE. However, this information is not necessary transmitted through the flow suspend request message and instead may be transmitted through a new message in a different format.

In step S524, the base station may forward the uplink data, received from the base station, to the core network. Specifically, if it is determined that the UE needs to enter the RRC_CONNECTED state, the base station may forward the uplink data by resuming the flow suspended between the base station and the core network (by performing steps S522 to S524). On the contrary, if it is not determined that the UE needs to enter the RRC_CONNECTED state, the base station may forward the uplink data without resuming the suspended flow between the base station and the core network (omitting steps S522 to S524). In the case where the uplink data is forwarded while the suspend flow remains as suspended, the UE does not need to perform the procedure of entering the RRC b and unnecessary flows are not used, and therefore, resources may be used efficiently.

In step S526, after the uplink data is received from the UE (step S516), the base station may, in response to the received uplink data, transmit ACK (acknowledgement) and perform a contention resolution procedure including C-RNTI(Cell-Radio Network Temporary Identifier), TAI(tracking area identity), etc. In addition, the response may include RRC state indicator. For example, according to the RRC state indicator, the UE may trigger RRC state transition (transition to the RRC_CONNECTED state) and maintain the RRC state (maintain the RRC_INACTIVE state).

According to embodiments of the present invention, the base station may control a flow according to the RRC state of the UE and efficiently manage resources for the UE. In addition, the core network in the NR may be able to be aware of an actual RRC state of the UE based on signaling between the base station and the core network and may provide a specific process for the UE even in the RRC_INACTIVE state.

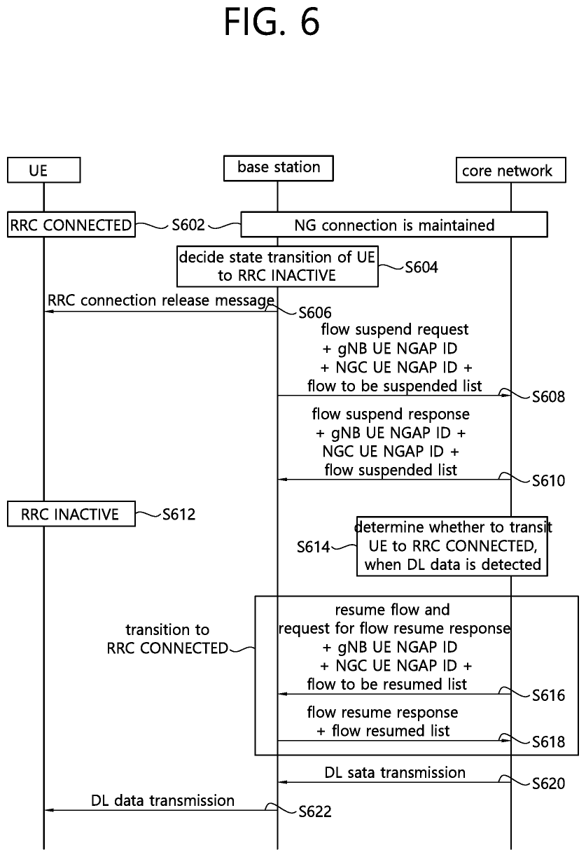

FIG. 6 is a flowchart illustrating a method for controlling a flow according to another embodiment of the present invention. This embodiment relates to a method for controlling a flow when downlink data to be transmitted to a UE is generated on the side of a core network.

In step S602 a UE may be in an RRC_CONNECTED state.

In step S604, if data is not transmitted for a preset period of time, the UE may determine to transition the UE from the RRC_CONNECTED state to an RRC_INACTIVE state.

In step S606, a base station may transmit an RRC connection release message. The RRC connection release message may include an indicator indicating that the UE is to enter the RRC_INACTIVE state. The RRC connection release message may include UE ID allocated by a previous serving base station, and, if the UE wishes to communicate with the base station, the base station may identify UE context using the UE ID. However, an indicator indicating the RRC_INACTIVE state and/or the UE ID is not necessarily transmitted through the RRC connection release message and instead may be transmitted through a new message in a different format.

In step S608, the base station may transmit a flow suspend request message including a list of flows necessary to be suspended as the UE transitions to the RRC_INACTIVE state. Here, the flows necessary to be suspended may indicate flows that is not operable without the UE's entering the RRC_CONNECTED state. That is, the base station may request to suspend all other flows, except for the minimum flows that are operable even though the UE is in the RRC_INACTIVE state. For example, whether is it necessary to be suspended may be preset for each flow depending on whether a corresponding flow is operable even in the RRC_INACTIVE state, whether the corresponding flow is frequently requested or highly referred by a user, or the like. In addition, a flow necessary to be suspended may be set by a user or a network. The flow suspend message may include gNB UE NGAP ID and NGC UE NGAP ID. The gNB UE NGAP ID and the NGC UE NGAP I may be allocated to the UE by the base station and the core network, respectively. However, this information is not necessary transmitted through the flow suspend request message and instead may be transmitted through a new message in a different format.

In step S610, the core network may transmit a flow suspend response message to the base station in response to the flow suspend request message. The flow suspend response message may include a list of flows suspended by the core network. In response to receiving the flow suspend request message from the base station, the core network may recognize that the UE is in the RRC_INACTIVE state. In other words, the core network may recognize the flow suspend request message as an indicator indicating the RRC state (RRC_INACTIVE state) of the UE. However, this information is not necessary transmitted through the flow suspend request message and instead may be transmitted through a new message in a different format.

In step S612, the UE may enter the RRC_INACTIVE state in response to receiving the RRC connection release message from the base station (see the step S506).

In step S614, if downlink data to be transmitted to the UE is generated on the side of the core network, the core network may determine whether the UE needs to enter the RRC_CONNECTED state. Specifically, if a size of the downlink data to be transmitted to the UE is equal to or greater than a preset value, the core network may determine that the UE needs to enter the RRC_CONNECTED state. That is, the fact that the UE needs to enter the RRC_CONNECTED state may mean that it is difficult to perform a series of operations including transmitting of uplink data, simply by a flow maintained between the base station and the core network. If the downlink to be transmitted to the UE has a small size, the core network may determine that the UE is capable of maintaining the RRC_INACTIVE state. That is, in the case where it is possible to transmit downlink data when some flows are currently suspended, the core network may determine that the UE is capable of maintaining the RRC_INACTIVE state.

In step S616, if it is determined that the UE needs to enter the RRC_CONNECTED state, the core network may resume the suspended flow. In addition, the core network may transmit a flow resume response request message to the base station. In this case, the core network may transmit a list of resume target flows to the base station.

In step S618, the base station may transmit a flow resume response message to the core network in response to the flow resume response request message. The base station may transmit a list of flows resumed by the flow resume response message to the core network. Meanwhile, by resuming the suspended flow, the core network may recognize that the UE attempts to enter the RRC_CONNECTED state.

In step S620, the core network may transmit the downlink data to the base station. Specifically, if it is determined that the UE needs to enter the RRC_CONNECTED state, the core network may transmit the downlink data to the base station by resuming the suspended flow (by performing steps S616 and 618). On the contrary, if it is not determined that the UE needs to enter the RRC_CONNECTED state, the core network may transmit the downlink data to the base station without resuming the suspended flow (omitting steps S616 and S618). In the case where the downlink data is transmitted while the suspended flow remains as suspended, the UE does not need to perform the procedure of entering the RRC connected state and unnecessary flows are not used, and therefore, resources may be used efficiently.

In step S622, the base station may forward the downlink data, received from the core network, to the UE. To this end, the base station may perform RAN paging. Specifically, the UE may confirm a location of the UE by responding to the base station in response to the RAN paging. In addition, the base station may transmit an RRC state indicator. For example, according to the RRC state indicator, the UE may trigger RRC state transition (transition to the RRC_CONNECTED state) and maintain the RRC state (maintaining the RRC_INACTIVE state).

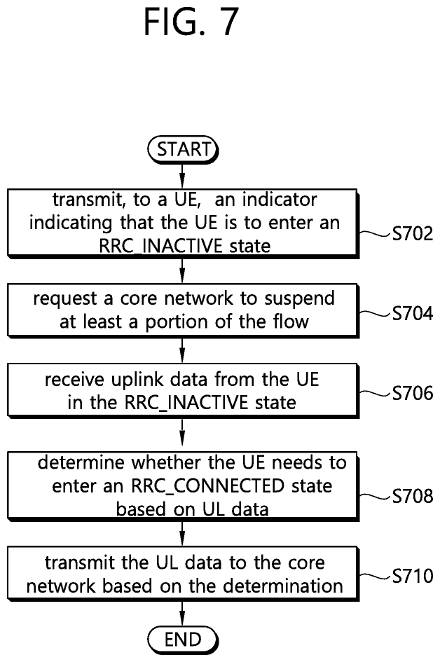

FIG. 7 is a flowchart illustrating a method for controlling a flow according to an embodiment of the present invention.

In step S702, a base station may transmit, to a base station, an indicator indicating that the UE is to enter an RRC_INACTIVE state.

In step S704, as the UE enters the RRC_INACTIVE state, the base station may request a core network to suspend at least some flows. A flow may be an element of a session established between the base station and the core network.

In step S706, the base station may receive uplink data from the UE in the RRC_INACTIVE state. In addition, the base station may receive, from the UE, UE ID (identity) and a short message authentication code for integrity (short MAC-1) together with the uplink data.

In step S708, the base station may determine whether the UE needs to enter the RRC_CONNECTED state, based on the uplink data. If a size of the uplink data is smaller than a preset value and there is no downlink to be transmitted to the UE, the base station may determine that the UE does not need to enter the RRC_CONNECTED state.

In step S710, the base station may transmit the uplink data to the core network according to a result of the determination. If the determination result indicates that the UE does not need to enter the RRC_CONNECTED state, the base station may transmit the uplink data using any other ongoing flow, except the suspended flow. In addition, if the result of the determination indicates that the UE is to enter the RRC_CONNECTED state, the base station may request resume of the suspended flow to the core network and may be notified by the core network that the suspended flow is resumed. In addition, the base station may transmit gNB UE NGAP ID and NGC UE NGAP ID to the core network at the same time when requesting the core network to resume the suspended flow.

Thereafter, the base station may transmit, to the UE, an RRC state indicator indicating whether to enter the RRC_CONNECTED state or maintain the RRC_INACTIVE state. In addition, the base station may transmit, to the UE, C-RNTI(Cell-Radio Network Temporary Identifier) and TAI(tracking area identity) together with the RRC state indicator.

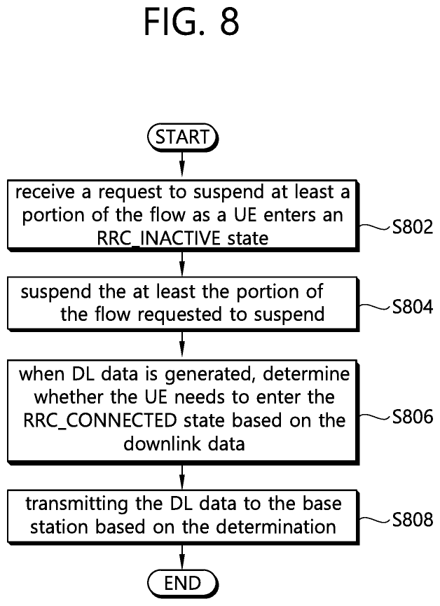

FIG. 8 is a flowchart illustrating a method for controlling a flow according to another embodiment of the present invention.

In step S802 a core network may be requested by a base station to suspend at least a portion of the flow as a UE enters an RRC_INACTIVE state. The flow may be an element of a session established between the base station and the core network.

In step S804, the core network may suspend the flow requested to suspend.

In step S806. If downlink to be transmitted to the UE is generated, the core network may determine whether the UE needs to enter an RRC_CONNECTED state, based on the downlink data. If a size of the downlink data is equal to or smaller than a preset value, the core network may determine that the UE does not enter the RRC_CONNECTED state.

In step S808, the core network may transmit the downlink data to the base station according to a result of the determination. If the result of the determination indicates that the UE is not going to enter the RRC_CONNECTED state, the core network may transmit the downlink data using an ongoing flow, except the suspended flow. If the determination result indicates that the UE is to enter the RRC_CONNECTED state, the core network may resume the suspended flow and notify the base station that the suspended flow is resumed.

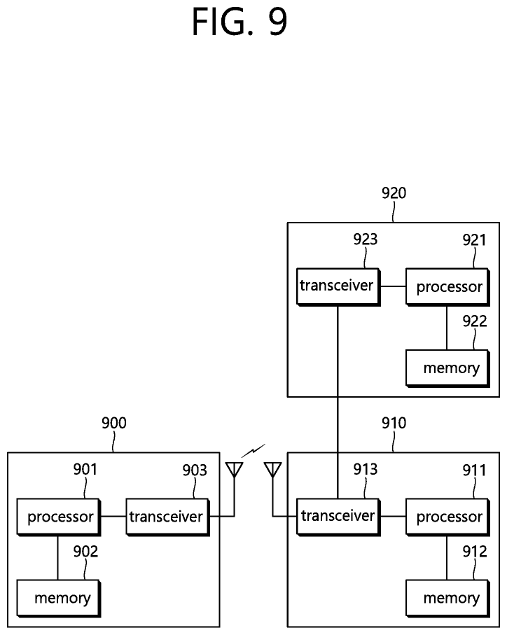

FIG. 9 is a block diagram illustrating a wireless apparatus in which an embodiment of the present invention can be implemented.

A UE 900 includes a processor 901, a memory 902, and a radio frequency (RF) unit 903. The memory 902 is coupled to the processor 901, and stores a variety of information for driving the processor 901. The RF unit 903 is coupled to the processor 901, and transmits and/or receives a radio signal. The processor 901 implements the proposed functions, procedures, and/or methods. In the aforementioned embodiments, an operation of the BS may be implemented by the processor 901.

ABS 910 includes a processor 911, a memory 912, and an RF unit 913. The memory 912 is coupled to the processor 911, and stores a variety of information for driving the processor 911. The RF unit 913 is coupled to the processor 911, and transmits and/or receives a radio signal. The processor 61 implements the proposed functions, procedures, and/or methods. In the aforementioned embodiments, an operation of the UE 910 may be implemented by the processor 911.

An MME/AMF 920 includes a processor 921, a memory 922, and a transceiver 923. The memory 922 is connected to the processor 921 and stores a diversity of information to drive the processor 921. The transceiver 923 may be connected to the processor 921 and transmit and/or a radio signal. The processor 921 implements the proposed functions, procedure, and/or methods. Operation of the MME/AMP in the above-described embodiments may be performed by the processor 921.

The processors 911 may include application-specific integrated circuit (ASIC), other chipset, logic circuit and/or data processing device. The memories may include read-only memory (ROM), random access memory (RAM), flash memory, memory card, storage medium and/or other storage device. The RF units may include baseband circuitry to process radio frequency signals. When the embodiments are implemented in software, the techniques described herein can be implemented with modules (e.g., procedures, functions, and so on) that perform the functions described herein. The modules can be stored in memories and executed by processors. The memories can be implemented within the processors or external to the processors in which case those can be communicatively coupled to the processors via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the scope of the appended claims.

What is claimed is:

1. A method for controlling a flow by a base station in a wireless communication system, the method comprising:
transmitting, to a UE, an indicator indicating that the UE is to enter an RRC_INACTIVE state;
requesting a core network to suspend at least a portion of the flow as the UE enters the RRC_INACTIVE state;
receiving uplink data from the UE in the RRC_INACTIVE state;
determining whether the UE needs to enter an RRC_CONNECTED state based on the uplink data; and
transmitting the uplink data to the core network based on a result of the determination.

2. The method of claim 1, wherein the flow is an element of a session established between the base station and the core network.

3. The method of claim 1, wherein the determining of whether the UE needs to enter the RRC_CONNECTED state comprises, when a size of the uplink data is smaller than a preset value and there is no downlink data to be transmitted to the UE, determining that the UE does not need to enter the RRC_CONNECTED state.

4. The method of claim 1, wherein, when the determination result indicates that the UE does not need to enter the RRC_CONNECTED state, the transmitting of the uplink data comprises transmitting the uplink data using an ongoing flow, except the suspended flow.

5. The method of claim 1, wherein, when the result of the determination indicates that the UE needs to enter the RRC_CONNECTED state, the transmitting of the uplink data comprises:
requesting the core network to resume the suspended flow; and
receiving, from the core network, a notification indicating that the suspended flow is resumed.

6. The method of claim 5, wherein the requesting of the core network to resume the suspended flow comprises transmitting ID of an NG application protocol between the base station and the UE (gNB UE NGAP ID) and ID of an NG application protocol (NGC UE NGAP ID) between the core network and the UE to the core network.

7. The method of claim 1, wherein the receiving of the uplink data from the UE comprises receiving UE identity (ID) and a short message authentication code for integrity (short MAC-I) from the UE.

8. The method of claim 1, further comprising, after the determining of whether the UE needs to enter the RRC_CONNECTED state, transmitting, to the UE, an RRC state indicator indicating that whether to enter the RRC_CONNECTED state or maintain an RRC_INACTIVE state.

9. The method of claim 8, wherein the transmitting of the RRC state indicator comprises transmitting Cell-Radio Network Temporary Identifier (C-RNTI) and tracking area identity (TAI( ) to the UE.

10. A method for controlling a flow by a core network in a wireless communication system, the method comprising:
receiving a request, from a base station, to suspend at least a portion of the flow as a UE enters an RRC_INACTIVE state;
suspending the at least the portion of the flow requested to suspend;
when downlink data to be transmitted to the UE is generated, determining whether the UE needs to enter the RRC_CONNECTED state based on the downlink data; and
transmitting the downlink data to the base station based on a result of the determination.

11. The method of claim 10, wherein the flow is an element of a session established between the base station and the core network.

12. The method of claim 10, wherein the determining of whether the UE needs to enter the RRC_CONNECTED state comprises, when a size of the downlink data is smaller than a preset value, determining that the UE does not need to enter the RRC_CONNECTED state.

13. The method of claim 10, wherein, when the result of the determination indicates that the UE does not need to enter the RRC_CONNECTED state, the transmitting the downlink data comprises transmitting the downlink data using an ongoing flow, except the suspended flow.

14. The method of claim 10, wherein, when the result of the determination indicates that the UE needs to enter the RRC_CONNECTED state, the transmitting of the uplink data comprises:
resuming the suspended flow; and
transmitting, to the base station, a notification indicating that the suspended flow is resumed.

15. A base station for controlling a flow in a wireless communication system, the base station comprises a memory, a transceiver, and a processor configured to connect the memory and the transceiver, wherein the processor is further configured:
transmit, to a UE, an indicator indicating that the UE is to enter an RRC_INACTIVE state;
request a core network to suspend at least a portion of the flow as the UE enters the RRC_INACTIVE state;
receive uplink data from the UE in the RRC_INACTIVE state;
determine whether the UE needs to enter an RRC CONNECTED state based on the uplink data; and
transmit the uplink data to the core network based on a result of the determination.
